(19) United States
(12) Patent Application Publication
(10) Pub. No.: US 2012/0069737 A1
(43) Pub. Date: Mar. 22, 2012

(54) OVERLOAD AVOIDANCE WITH HOME NODE B GATEWAY (HENB GW) IN LTE

(75) Inventors: Jari Vikberg, Jarna (SE); Tomas Nylander, Varmdo (SE); Johan Rune, Lidingo (SE)

(73) Assignee: TELEFONAKTIEBOLAGET L M ERICSSON (PUBL), Stockholm (SE)

(21) Appl. No.: 13/256,542

(22) PCT Filed: Jun. 25, 2009
(86) PCT No.: PCT/SE09/50807

§ 371 Date: Sep. 14, 2011

Related U.S. Application Data
(60) Provisional application No. 61/164,083, filed on Mar. 27, 2009.

(51) Int. Cl. H04W 48/06

(52) U.S. Cl. 370/232

(57) ABSTRACT

Systems and methods for handling signaling connection establishment in systems which include home gateways (502, 800) are described. A request is received, by a home gateway (502, 800), to establish a signaling connection, which request includes a reason for requesting establishment of that signaling connection. The home gateway (502, 800) determines whether to establish the signaling connection based upon that reason plus a load status of at least one of the home gateway (502, 800) itself and a core network node (208).

### TECHNICAL FIELD

The present invention relates generally to communications and in particular to methods, devices and systems for signal connection handling in radiocommunications systems having home gateways.

### BACKGROUND

Radiocommunication networks were originally developed primarily to provide voice services over circuit-switched networks. The introduction of packet-switched bearers in, for example, the so-called 2.5 generation (G) and 3G networks enabled network operators to provide data services as well as voice services. Eventually, network architectures will likely evolve toward all Internet Protocol (IP) networks which provide both voice and data services. However, network operators have a substantial investment in existing infrastructures and would, therefore, typically prefer to migrate gradually to all IP network architectures in order to allow them to extract sufficient value from their investment in existing infrastructures. Also to provide the capabilities needed to support next generation radiocommunication applications, while at the same time using legacy infrastructure, network operators could deploy hybrid networks wherein a next generation radiocommunication system is overlaid onto an existing circuit-switched or packet-switched network as a first step in the transition to an all IP-based network. Alternatively, a radiocommunication system can evolve from one generation to the next while still providing backward compatibility for legacy equipment.

Specification is ongoing in 3GPP for Evolved Universal Terrestrial Radio Access Network (E-UTRAN) that is the next generation of Radio Access Network (RAN). Another name for E-UTRAN, used in the present specification, is Long Term Evolution (LTE) RAN. The core network to which E-UTRAN is connected is called Evolved Packet Core (EPC), also known as System Architecture Evolution (SAE) network. Both the E-UTRAN and the EPC (and possibly some other node(s), such as the Home Subscriber Server (HSS), depending on the definition of the EPC) comprise together the Evolved Packet System (EPS), which is also known as the SAE/LTE network. A base station in this concept is called an E-UTRAN NodeB (eNodeB or eNB). These ongoing studies also include the possibility to have an E-UTRAN base station which provides home or small area coverage for a limited number of users. This base station is, in 3GPP and in this document, called a Home E-UTRAN NodeB (HeNB) or home base station. Other names used for this type of base station are LTE Home Access Point (LTE HAP) and LTE Femto Access Point (LTE FAP).

The HeNB would typically provide normal service for the end users and would be connected to the mobile core network using an IP-based transmission link. The radio service coverage provided by an HeNB is called a femtocell in this specification. Furthermore, a femtocell is normally a Closed Subscriber Group (CSG) cell, i.e., a cell in which only a limited set of users is allowed to access the network. The HeNB would, in most cases, use the end user's already existing broadband connection (e.g. xDSL and Cable) to achieve connectivity to the operator's mobile Core Network (CN) and possibly to other eNBs/HeNBs. One of the main reasons for providing wireless local access using HeNBs and femtocells is to provide cheaper calls or transaction rates/charges when a device (e.g., a mobile phone) is connected via an HeNB as compared to when that device is connected via an eNB.

More generally, an HeNB and similar devices can be considered to be a sort of “home base station”. As used herein, the term “home” is used to modify the phrase “base station” to distinguish such equipment from other conventional base stations based upon characteristics such as one or more of: (1) geographic radio coverage provided (i.e., home base station coverage area <“regular” base station coverage area), (2) subscriber access (i.e., home base stations may limit subscribers who can obtain service from the home base station whereas a “regular” base station will typically provide access to any subscribers (or at least to a larger group of subscribers than a home base station) who are within range, and (3) home base stations are normally installed by the end users themselves without any intervention from the operator's personnel, whereas regular base stations are typically installed by operator personnel. This latter quality of home base stations suggests that the installation will generally be highly automated and of a “plug and play” nature. Note, however, that home bases stations need not literally be installed in personal residences, and may find applications in businesses, public areas, etc., wherein the qualities of a home base station are desirable to, e.g., supplement coverage provided by regular base stations. Home gateways, as the phrase is used herein, are gateways which interface home base stations with a node in the radiocommunication system, e.g., a core network node.

It is envisioned that a mobile radiocommunication network which implements this type of architecture may have several hundreds of thousands or even a million or more HeNBs or other types of home base stations connected thereto. Such a large number of access points will present various challenges relating to session handling. Accordingly, it would be desirable to have methods and systems which address session handling challenges/issues such as those posed by the introduction of home base stations.

### SUMMARY

These and other challenges are addressed by the exemplary embodiments described herein. The load status of either a home gateway, or a network node to which the home gateway is connected, is used as part of the basis for determining whether connection requests received from a home base station should be granted or denied. Signaling associated with high load handling is minimized to reduce overall system overhead.

For example, according to one exemplary embodiment, a method for signaling connection establishment in a home gateway, the home gateway being comprised in a radiocommunication network, is described. The method include the step of receiving, at the home gateway, a request from a home base station to establish a signaling connection towards a core network node, the request including information associated with a reason for requesting establishment of the signaling connection. Next, the method determines, at the home gateway, whether to establish the signaling connection based upon the information received in the request and a load status associated with at least one of: (a) the home gateway and (b) the core network node in the radiocommunication network.

According to another exemplary embodiment, a home gateway includes a first interface configured to transmit signals to, and receive signals from, a plurality of home base stations. The received signals include, for example, a request to establish a signaling connection which request includes information associated with a reason for requesting establishment of the signaling connection. The home gateway also includes a second interface configured to transmit signals to, and receive signals from, at least one core network node associated with a radiocommunication network. The home gateway further includes at least one processor configured to determine whether to establish the signaling connection based upon the information and a status associated with at least one of: (a) the home gateway and (b) the at least one core network node.

According to another exemplary embodiment, a method for signaling connection establishment in a home base station is described. The method includes transmitting, by the home base station, a request to establish a signaling connection towards a core network node. The request includes information associated with a reason for requesting establishment of the signaling connection.

### BRIEF DESCRIPTION OF THE DRAWINGS

The accompanying drawings illustrate exemplary embodiments, wherein:

FIG. 1 depicts an overview of a system within which exemplary embodiments can be implemented;

FIG. 2 illustrates an operator network in communication with an Evolved Universal Terrestrial Radio Access Network (E-UTRAN) in which exemplary embodiments can be implemented;

FIGS. 3-5 illustrate various portions of exemplary architectures including HeNBs and HeNB GWs according to exemplary embodiments;

FIG. 6(a) illustrates a signaling diagram according to an exemplary embodiment; 6(b)-6(d) are flow charts illustrating signaling connection decision process logic associated with the signaling diagram of FIG. 6(a) according to exemplary embodiments;

FIG. 7(a) illustrates a signaling diagram according to another exemplary embodiment;

FIG. 7(b) is a flow chart illustrating signaling connection decision process logic associated with the signaling diagram of FIG. 7(a) according to exemplary embodiments;

FIG. 8 depicts a communications node according to exemplary embodiments; and

FIG. 9 is a flow chart illustrating a method for signaling connection establishment in a home gateway.

### ABBREVIATIONS

3G 3^{rd} Generation
3GPP 3^{rd} Generation Partnership Project
CN Core Network
CSG Closed Subscriber Group
DSCP DiffServ Code Point
eNodeB E-UTRAN NodeB
eNB E-UTRAN NodeB
EPC Evolved Packet Core
E-UTRAN Evolved UTRAN
FAP Femto Access Point
GPRS General Packet Radio Service
GUMMEI Globally Unique MME Identity
GUTI Globally Unique Temporary Identity
GW Gateway
HAP Home Access Point
HeNB Home eNB
HeNB GW Home eNB Gateway
HNB Home Node B
HNB GW Home Node B Gateway
ID Identity
IE Information Element
IP Internet Protocol
LTE Long Term Evolution
MCC Mobile Country Code
MME Mobility Management Entity
MMEC MME Code
MMEGI MME Group Identity
MNC Mobile Network Code
MSC Mobile Switching Centre
M-TMSI M-Temporary Mobile Subscriber Identity
NAS Non-Access Stratum
PLMN Public Land Mobile Network
PLMN ID PLMN Identity
QoS Quality of Service
RAN Radio Access Network
RANAP Radio Access Network Application Part
RRC Radio Resource Control
RUA RANAP User Adaptation
S1 Interface between eNB and CN, or between HeNB GW and CN, or between HeNB and HeNB GW, or between HeNB and CN
S1AP S1 Application Protocol
S1-MME Control Plane of S1
S1-U User Plane of S1
SAE System Architecture Evolution
SCTP Stream Control Transmission Protocol
SGSN Serving GPRS Support Node
S-TMSI S-Temporary Mobile Subscriber Identity
SW Software
TA Tracking Area
TAI Tracking Area Identity
TAU Tracking Area Update
UE User Equipment
UTRAN Universal Terrestrial Radio Access Network
WCDMA Wideband Code Division Multiple Access
X2 Interface between eNBs
xDSL X Digital Subscriber Line (referring to the DSL family of technologies where “X” stands for any of the letters that can be placed before “DSL”, e.g. A or V)

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

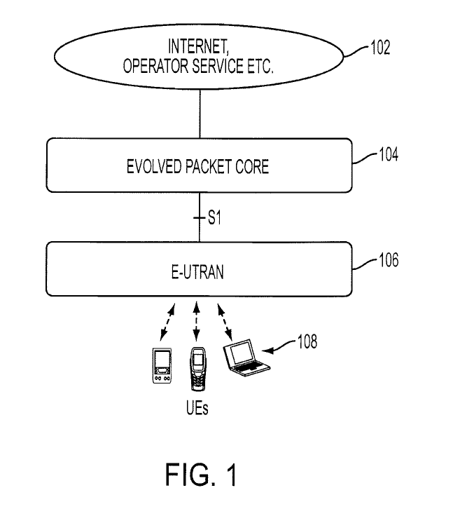

Prior to discussing other aspects of the exemplary embodiments below, a purely illustrative overview of a system in which signaling connections (or sessions) can be established will now be described with respect to FIGS. 1-5 to provide some context for this discussion. According to exemplary embodiments, a communication system in which signaling connections can be established is shown generally in FIG. 1 and includes various user equipments (UEs) 108, e.g., mobile phones, laptop computers and personal digital assistants (PDAs), which communicate over a wireless interface with an Evolved Universal Terrestrial Radio Access Network (E-UTRAN) 106. The E-UTRAN 106 communicates with nodes in the Evolved Packet Core (EPC) 104 over S1 interface(s). The EPC 104 can then route calls/requests from the UEs 108 to various separate networks and services as shown generally by the Internet/Operator Service 102.

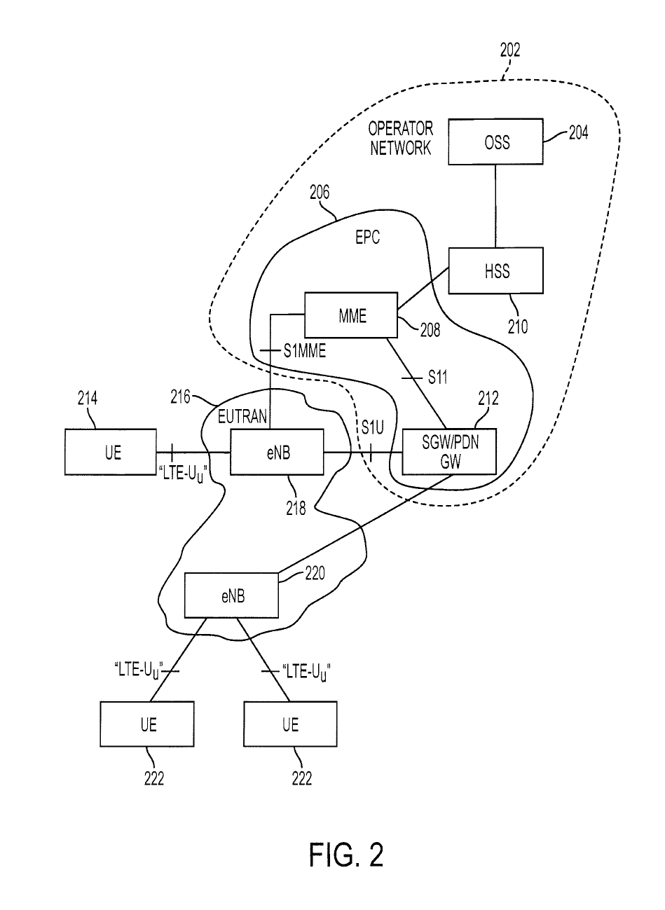

According to exemplary embodiments, a long term evolution (LTE) radio access network (RAN)/system architecture evolution (SAE) network can include various control functions and nodes for radio resource management. For example, FIG. 2 shows a simplified version of an Operator Network 202 which includes an Operations Support System (OSS) 204, a Home Subscriber Server (HSS) 210 and an Evolved Packet Core (EPC) 206. An OSS 204 is generally a focal point from which an operator can control the network 202 and perform functions such as configuration of network components and other operations/maintenance support functions. The EPC 206 includes a mobility management entity (MME) 208 which can perform (and/or support) various functions of the RAN such as, bearer management functions, authentication and gateway selection. The home subscriber server (HSS) 210 is a database containing subscriber information which supports authentication/authorization issues associated with UEs 214 (and other nodes). Note that the HSS 210 may sometimes, depending on the EPC definition, be considered a part of the EPC 206.

The EPC 206 also includes a Serving Gateway (SGW)/Packet Data Network Gateway (PDN GW) 212. The SGW function performs a variety of tasks, such as packet routing and forwarding, mobility anchoring for inter-3GPP mobility, i.e. mobility between different cellular network using 3GPP technology, as well as being the gateway which terminates the S1-U interface towards the E-UTRAN 216. The PDN GW (PGW) function also performs a variety of tasks, such as IP address allocation for nodes, and is a link to other networks, e.g., the Internet, as well as being an anchor point for mobility between 3GPP networks and non-3GPP networks. While shown as a single entity, the SGW/PDN GW 212 can be implemented as separate entities within the EPC 206.

The E-UTRAN 216 includes a number of eNodeBs (eNB) 218, 220 which communicate with the EPC 206 over versions of the S1 interface, e.g., S1-MME towards the MME(s) and S1-U towards the SGW(s). Additionally, the eNBs 218, 220 can communicate wirelessly with various UEs 214, 222 over a wireless interface denoted by “LTE-Uu”. The connection between the eNB 220 and an MME (which may be the same as or different from MME 208) is omitted to simplify the figure. Other connections have also been omitted to simplify the figure, e.g., the OSS 204 can be connected to all of the other nodes in the network in addition to the HSS 210. Additionally, it will be appreciated by those skilled in the art, and is described in more detail below, that an eNB can be connected to a plurality of MMEs. Moreover, the eNBs 218 and 220 may also be considered to be part of the operator network 202.

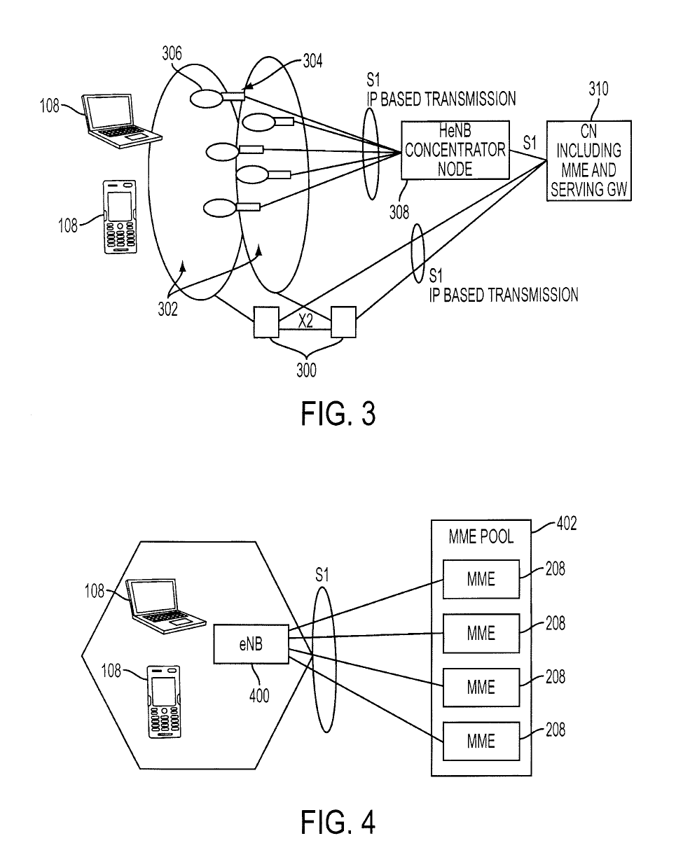

System architectures according to exemplary embodiments will also include HeNBs (or more generally “home base stations”) in addition to, potentially, those nodes illustrated in FIG. 2. FIG. 3 shows aspects of an exemplary LTE RAN architecture and relevant interfaces with, for example, eNBs 300 serving macrocells 302 and HeNBs 304 serving femtocells or microcells 306. The HeNB Concentrator Node 308 shown in FIG. 3 is also referred to herein as an HeNB Gateway (HeNB GW) or, more generally, a “home gateway”. As used herein, the term “home” as it is used to modify the phrase “base station” is intended to distinguish such equipment from other conventional base stations based upon characteristics such as one or more of the three characteristics described above in the Background section of this application. Additionally, and purely as an example, an HeNB 304 will typically have only one S1 connection toward the network, i.e., its connection to the HeNB GW 308, whereas an eNB 300 will typically have multiple S1 “flex” connections toward various nodes in the network. Although the word “home” is used to distinguish these different types of equipment, it should be noted that home base stations are not limited to base stations which are literally disposed within a home nor are home base stations limited to base stations which provide radiocommunication service to only one home. For example, a home base station can be used to supplement coverage of a “regular” base station in congested public areas. Similarly, a home gateway is a gateway or concentrator node which connects one or more home base stations to a node in a core network 310, e.g., an SGW/PDN GW 212 and/or an MME 208, but is not itself typically located within a home. However, the home gateway node 308 may also provide some of the functionality which would otherwise be provided by the home base stations 304 so that these home base stations 304 can be kept relatively simple and cheap. One example of such functionality is the CN Pool (e.g., MME Pool) functionality (sometimes also denoted S1 flex as mentioned above) that can be implemented in the home gateway node 308. The home gateway 308 may also hide the signaling load related to turning on and off the home base stations 304 from the core network 310. For example, when an HeNB 304 is powered on and off then only the S1 interface between the HeNB 304 and the HeNB GW 308 is affected (e.g. established, torn down, re-established, etc.) without the involvement of the MME(s) 208. UEs 108 which are located within a femtocell 306 may obtain radiocommunication service from either that femtocell or the overlapping macrocell 302 (if one is present), according to rules established for this particular network.

As mentioned above in the Background section, a mobile network may have several hundreds of thousands or a million or more HeNBs 304. It is anticipated that the control nodes in the CN 310 (e.g., MMEs 208) will not be able to handle that many HeNBs 304, i.e., the handling of that many S1 control parts or interfaces (S1-MME(s) seems unreasonable. Therefore, one purpose of the HeNB GW 308 is to conceal the large number of HeNBs 304 from the CN 310. The HeNB GW 308 will, from the CN's perspective (S1 interface), look like one eNB with many cells. The HeNB GW 308 will act as an eNB proxy for all the HeNBs 304 that are connected to the HeNB GW 308. From an HeNB perspective, the HeNB GW 308 will look like CN 310 (also an S1 interface).

As seen in FIG. 4, an eNB 400 typically has S1 interfaces to all members in an MME pool 402, and the MMEs 208 have unique identities, referred to as GUMMEIs (Globally Unique MME Identities), that are conveyed to the eNB 400 when the S1 interface connection is established. When a UE 108 attaches to the network and to an MME 208, it is allocated an identity, e.g., a GUTI (Globally Unique Temporary Identity). A GUTI consists of two parts, one part that identifies the MME 208 which allocated the GUTI and which holds the UE context, and one part which identifies the UE 108 within the MME 208. The part that identifies the MME is a Globally Unique MME Identity (GUMMEI), which in turn consists of a PLMN ID (i.e., MCC+MNC), an MME group identity (MMEGI) which identifies the MME pool and an MME code (MMEC) which identifies the MME within the pool. The part of the GUTI that identifies the UE 108 within the MME 208 is called M-TMSI. The combination of MMEC and M-TMSI is denoted S-TMSI. The S-TMSI is used for identification of the UE 108 in situations where the PLMN ID and MMEGI are known.

When a UE 108 accesses an eNB 400 to establish an RRC signaling connection, it identifies itself with the S-TMSI in an RRCConnectionRequest message, if the TAI of the current cell is included in the UE's TAI list (i.e. if the UE 108 is registered in the current TA). Otherwise the UE 108 uses a random number as identity in the RRCConnectionRequest message. If the UE 108 provides the S-TMSI, the eNB 400 can use the MMEC part of the S-TMSI to figure out which MME 208 that holds the UE context. The UE 108 may also indicate the MME 208 in which it is registered by providing the GUMMEI of that MME 208 in the RRCConnectionSetupComplete message (which concludes the RRC connection establishment procedure).

When an RRC connection is established, the eNB 400 selects an MME 208 to establish an S1AP signaling connection with for this UE session. If the UE 108 has provided the eNB 400 with an identifier that can be used to derive an MME 208 which already holds the UE's context (e.g., an S-TMSI or GUMMEI) and if this MME 208 belongs to an MME pool 402 to which the eNB 400 is connected, then the eNB 400 selects this MME 208. Otherwise, if the UE 108 has not provided an identifier which indicates an MME 208 in an MME pool 402 that the eNB 400 is connected to (e.g. a GUMMEI indicating another MME pool or only a random number identity), then the eNB 400 uses a default algorithm to select an MME 208, e.g., a weighted round-robin selection algorithm.

If an MME 208 experiences a high load situation, it can inform the eNBs 400 about its status by sending the S1AP message ‘OVERLOAD START’. Note that as used herein, the phrases “high load” or “highly loaded” are intended to be inclusive of, but not limited to, load statuses such as “overloaded”, i.e., to reflect that signal connection handling according to these exemplary embodiments can be triggered based on any desired load threshold (or variable load thresholds) rather than only when a particular device becomes loaded to a point where it cannot function normally. An eNB 400 knows which MME 208 is highly loaded based upon which S1 connection it received the message on. The ‘OVERLOAD START’ message includes information about how the eNBs 400 should treat UE RRC connection attempts. Possible responses to such connection attempts can include: rejecting all RRC connection requests for non-emergency mobile originated data transfer, rejecting all new RRC connection requests for signaling and/or only permitting RRC connection establishments for emergency sessions or other high priority reasons which have been designated as part of an allowable signaling connection category.

When a UE 108 attempts to establish an RRC connection, an eNB 400 that has received an ‘OVERLOAD START’ message from an MME 208 evaluates the establishment cause that the UE 108 indicates in the RRCConnectionRequest message to determine if the RRC connection establishment is allowed based on the MME 208 holding the context for the UE and the high load status of this MME and, correspondingly, whether the signaling connection establishment should lead to the establishment of an S1AP connection by sending an ‘Initial UE message’ or if the RRC connection attempt should be rejected. When the high load condition ceases in the MME 208, the MME 208 sends an ‘OVERLOAD STOP’ message and the eNB 400 can resume normal handling again.

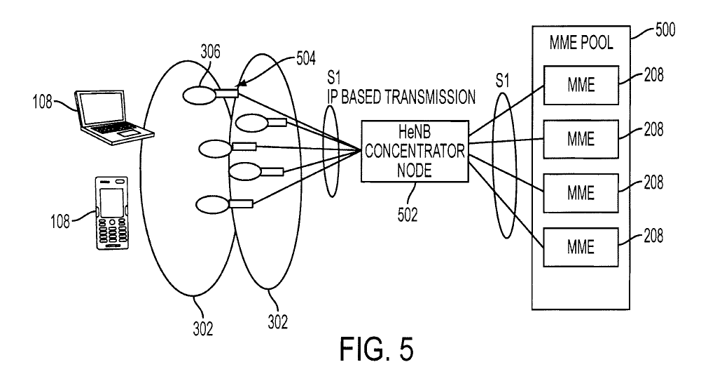

According to exemplary embodiments, there arises the issue of how to handle high load situations of, e.g., an MME, for architectures which involve the afore-described home base stations and home gateways. FIG. 5 shows an example of an MME pool 500 and a HeNB Gateway 502 connected to CN pool nodes 208 and home base stations 504 in an exemplary LTE RAN in more detail. In a scenario where an HeNB GW 502 is deployed, an HeNB 504 should only have one S1 interface to the allocated HeNB GW 502, and the HeNB GW 502 is the entity that has multiple S1 interfaces to the different MMEs 208 in a pool 500. The HeNB GW 502 handles the selection of the MME 208 to use for a given connection/UE. However, high load handling processes such as those described above for an eNB will not work well in a HeNB GW scenario since, for example, such typical high load handling processes will significantly increase complexity. Thus, the high load problem has at least two facets, one being when an MME 208 is highly loaded, the other being when an HeNB GW 502 is highly loaded.

More specifically, an HeNB GW 502 experiencing an high load situation or receiving an ‘OVERLOAD START’ message from an MME 208, would typically need to implement logic to forward this information to all connected HeNBs 504, which potentially could be, for example, several hundreds of thousands of messages since high capacity HeNB GWs, serving large numbers of HeNBs, are desired and expected to be implemented. In case of MME 208 high load, this information would also be signaled to HeNBs 504 that might not even have UEs 108 that use the affected MME 208. This massive amount of signaling (and the non-negligible time it may take to perform) is in itself a problem because, for example (a) such signaling uses processor power and bandwidth and causes increased complexity, (b) the high load condition may cease during the process of informing the HeNBs 504 (especially since the duration of the process may be significant if the number of HeNBs is great), or (c) sessions directed towards the MME 208 experiencing high load may be received from HeNBs 504 which have not yet been informed (also this risk increases with the number of HeNBs, since the larger the number of HeNBs, the more potential sources of sessions via HeNBs and the longer the duration of the process will be). Furthermore, in a typical ‘OVERLOAD START’ message which is sent to an eNB as described above, there is no mechanism for indicating which MME 208 is affected (e.g., highly loaded) since the affected source is determined implicitly based on the S1 signaling connection that the overload message is received on. If such a load handling approach were used directly in an architecture having HeNBs 504 and HeNB GWs 502, this could mean that an HeNB 504 receiving an overload message would have to stop all session establishments as indicated in the message, even though the UE's 108 attached to the HeNB 504 might be allocated to other MMEs 208 which are not highly loaded and which can handle new signaling connection attempts. Moreover, high load situations might occur simultaneously in an HeNB GW 502 and in MMEs 208, generating very complex load handling scenarios.

According to exemplary embodiments, the HeNB GW 502 handles such high load situations associated with MMEs 208 and HeNB GWs 502 itself without necessarily propagating this information to any home base station, e.g., HeNB 504. Moreover, according to exemplary embodiments, the high load situation can be checked and handled by a home gateway 502 when needed, i.e., when a session or signaling connection is about to be established. The S1AP Initial UE message is extended according to exemplary embodiments to include an optional indication of the RRC establishment reason, e.g., an HeNB can include this information in an S1AP Initial UE message. Moreover, exemplary embodiments are applicable to other radiocommunication systems, e.g., WCDMA (3G) femto solutions, where a HNB GW may handle high load situations.

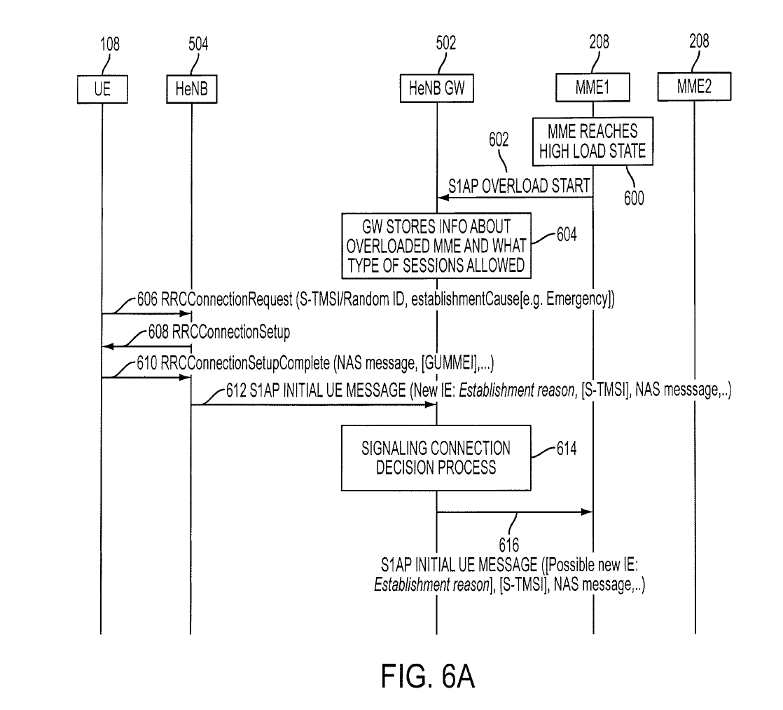

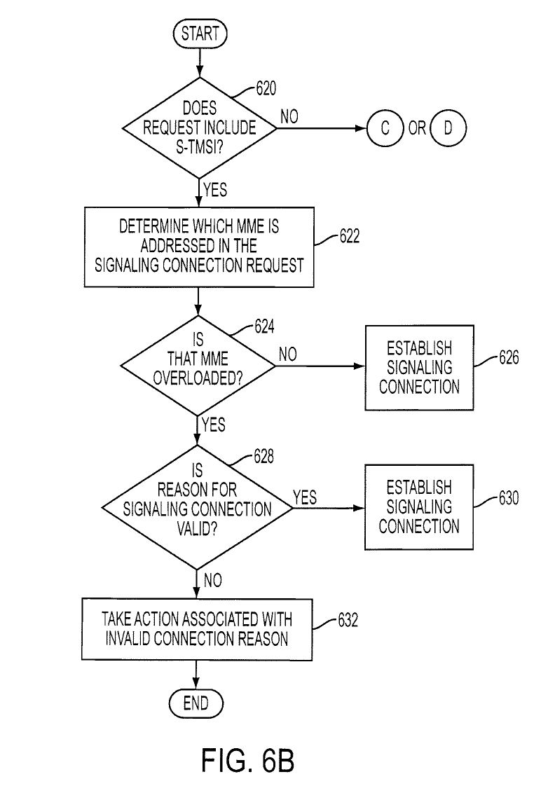

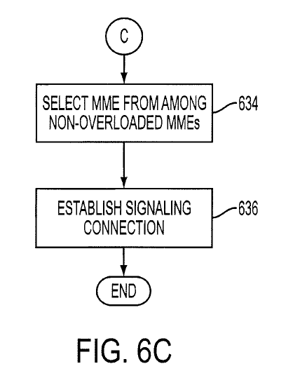

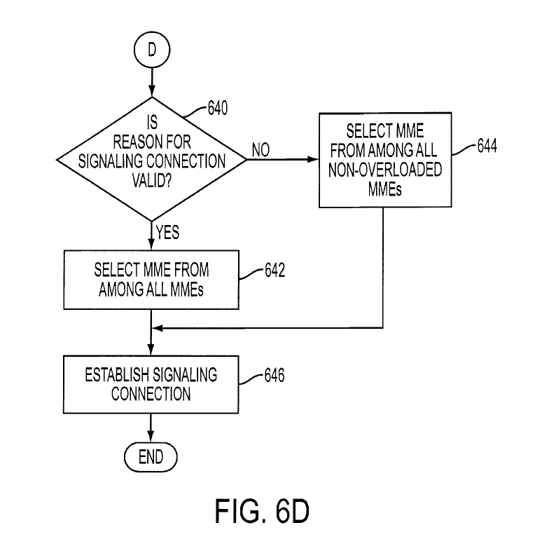

FIG. 6(a) illustrates a signaling diagram according to an exemplary embodiment, including decision logic associated with selective signaling connection. At block 600, one MME 208 in an MME pool (including MME1 and MME2) reaches a high load state and decides that it should inform the eNBs to which it is connected of its high load state. In this exemplary scenario, at least one of that MME1's perceived eNBs is actually an HeNB GW 502 (the other eNBs are not shown in FIG. 6(a)). As indicated by signal 602 in FIG. 6(a), the MME1 208 sends an SLAP OVERLOAD START message to an HeNB GW 502. However, it will be appreciated that, in an actual implementation, the MME1 208 would send an S1AP OVERLOAD START signal, or the like, to all or a selected subset of the HeNB GWs 308 and eNBs to which it was connected. This message 602 can also include information regarding what types of signaling connections or sessions, e.g., high priority or emergency sessions, are allowed to be established with the highly loaded MME1 208. At block 604, the HeNB GW 502 recognizes which MME 208 is highly loaded based on the S1 interface over which the message is received. The HeNB GW 502 marks or stores an indication that this MME1 208 needs special handling and can, for example, store information about which type of sessions that are allowed.

When a UE 108 having service provided by an HeNB 504 wants to establish a session or signaling connection, the UE 108 indicates the reason for the establishment in the establishmentCause IE in the RRCConnectionRequest message 606, which message is transmitted to its serving home base station 504, e.g., reasons such as Emergency, Mobile Originated Signaling, Mobile Originated Data, etc. If the TAI of the current cell is included in the UE's TAI list, the UE 108 includes its S-TMSI as the UE identity in the RRCConnectionRequest message 606. Otherwise the UE 108 includes a random number as the UE identity in the RRCConnectionRequest message 606. The HeNB 504 acknowledges the establishment via signal 608 and the UE 108 completes the RRC establishment procedure via signal 610, and includes the upper layer message, i.e., the NAS message in the RRC message. The UE 108 may include the GUMMEI of the MME 208 that holds its context in the RRCConnectionSetupComplete message 610.

At this point in the process illustrated in FIG. 6(a), the HeNB 504 is not aware of the MME pool and, more particularly, that one member of the MME pool is in a high load state. Since an HeNB 504 only has an S1 connection to an HeNB GW 502 according to this exemplary embodiment, which connection appears to the HeNB 504 as a single MME 208, the HeNB 504 sends a S1AP INITIAL UE MESSAGE (signal 612) towards the HeNB GW 502 to establish an S1AP signaling connection for this UE session. The HeNB 504 includes the NAS message received from the UE 108, and adds other information to signal 612, e.g., the TAI of the UE's current cell. If the UE 108 included an S-TMSI in the RRCConnectionRequest message, the HeNB 504 includes the S-TMSI in the S1AP INITIAL UE MESSAGE. According to this exemplary embodiment, the HeNB also adds an indication of, or information associated with, the reason for the establishment in the message transmitted as signal 612. This information could be the establishmentCause received in the RRCConnectionRequest 606 or, for example, could instead only be an ‘emergency indicator’ that is optionally included at emergency setups. This new information element can be optional and could, for example, only be inserted when an HeNB 504 (or eNB) has an S1 connection to only one destination, when the HeNB 504 (or eNB) serves a CSG cell or when the cell accessed by the UE 108 is a CSG cell. These modes of operation would implicitly indicate that an HeNB GW 502 might be in the signaling path.

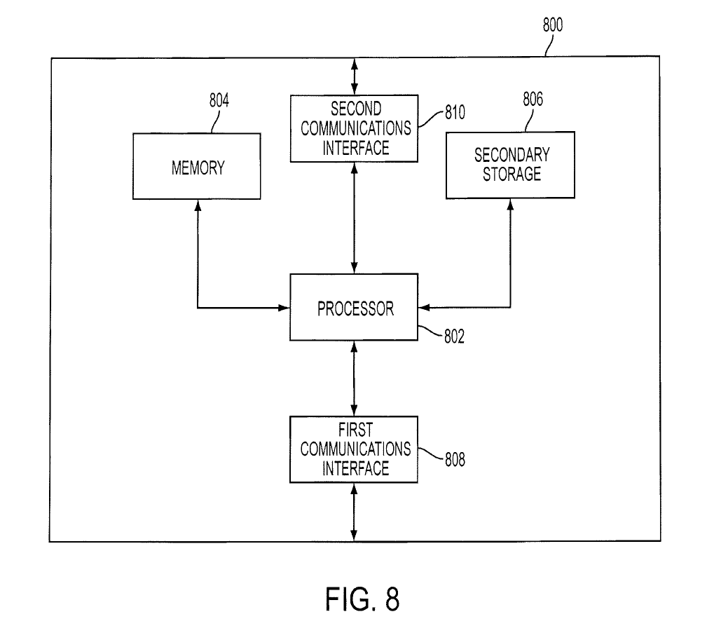

Referring now to block 614 in FIG. 6(a), upon receiving a new signaling connection (or session establishment) request the HeNB GW 502 performs a signaling decision process, an example of which is illustrated in the flow charts of FIGS. 6(b)-6(d). Starting with FIG. 6(b), if the S1AP INITIAL UE MESSAGE 612 received by the HeNB GW 502 contains an S-TMSI at step 620, the HeNB GW 502 determines the addressed MME 208 from the MMEC in the received S-TMSI (step 622) and checks the status of that MME 208 at step 624, e.g., by checking the portion of its memory which is assigned to store a highly loaded/not highly loaded indication for that particular MME 208. If no current high load has been indicated for that MME 208, then normal handling applies and the HeNB GW 502 forwards the message to the addressed MME 208 to establish a signaling connection at step 626, e.g., as shown in FIG. 6(a) by signal 616. If, on the other hand, the addressed MME 208 has an indicated a high load condition, then the process follows the ‘Yes’ branch to step 628 wherein the HeNB GW 502 determines what type of sessions/signaling connections are allowed to be established to this highly loaded MME 208. If the reason received by the HeNB GW 502 in the message 612 corresponds to an allowable category for signaling connection establishment to this MME 208 when it is highly loaded, e.g. an emergency call setup or a sufficiently high priority session, the HeNB GW 502 forwards the message to the addressed MME 208 at step 630 and continues to establish the signaling connection as normally. As with the highly loaded/not highly loaded indication the category or categories of allowable types of signaling connections for an MME 208 in a high load state can, for example, be stored in the HeNB GW 502's memory (shown in FIG. 8 and described below) for each MME 208 in a high load state in a pool (e.g. stored in step 604) or collectively for all MMEs if they share the same rule set for handling signaling connection establishment when highly loaded.

If, however, the received reason for establishment is not allowed at step 628, the HeNB GW 402 can have different policies, one or more of which may then be applied to handle the message 612 as indicated by step 632. For example, the HeNB GW 502 can reject the session/signaling connection establishment by sending an S1AP RESET message to the HeNB 504 (signal not shown in FIG. 6(a)), which would then be acknowledged by a responsive signal sent by the HeNB 504 back to the HeNB GW 502. Alternatively, the HeNB GW 502 can drop the received message 612 and let the UE 108 and/or the HeNB 504 timeout actions occur. Still yet another alternative at step 632 would be for the HeNB GW 502 to select another MME 208 in the MME pool that has not indicated a high load by evaluating the load indications stored in its memory. Those skilled in the art will appreciate that these three policies for handling connection establishment requests with invalid reasons toward a highly loaded core network node, e.g., an MME 208, are purely exemplary and that other policies could be implemented.

Returning now to step 620 in FIG. 6(b), if the S1AP INITIAL UE MESSAGE 612 does not include an S-TMSI, then there is no particular MME 208 to which the signaling connection request is addressed and the HeNB GW 502 may, according to this exemplary embodiment, act in one of two different ways to handle the request as illustrated in the flowcharts of FIGS. 6(c) and 6(d), respectively. In a first variant, if the request message does not contain an S-TMSI (or other identifier containing MME identity) in the S1AP INITIAL UE MESSAGE 612 at step 620 in FIG. 6(b), the flow then proceeds to the flowchart of FIG. 6(c). Therein, the HeNB GW 502 does not check the reason for establishment. Instead the HeNB GW 502 always excludes the highly loaded MME(s) 208 from potential selection for new signaling connections at step 634. The HeNB GW 502 then uses its default MME selection algorithm to select one of the remaining (not in high load state) MMEs 208 in the pool, after which it establishes the signaling connection by sending the appropriate signal to the selected MME 208 at step 636.

In a second variant, if the request message does not contain an S-TMSI (or other identifier containing MME identity) in the S1AP INITIAL UE MESSAGE 612 at step 620 in FIG. 6(b), the flow then proceeds to the flowchart of FIG. 6(d), wherein the HeNB GW 502 still checks the reason for establishment of the requested signaling connection at step 640. If the information provided in the request message 612 indicates a reason that is allowed by MMEs 208 in high load state, e.g., an emergency call, then the HeNB GW 504 performs regular MME selection using its default MME selection algorithm (e.g., weighted round-robin) among all the MMEs 208 in the pool at step 642. Otherwise, if the reason for signaling connection establishment is not allowed by MME(s) 208 in high load state, the HeNB GW 504 excludes the MME(s) 208 in high load state from the MME selection process at step 644 and uses its default MME selection algorithm to select one of the remaining (not in high load state) MMEs 208 in the pool. After either step 642 or step 644, the signaling connection is established to the selected MME 208, e.g., by transmitting the message 616 from the HeNB GW 504 to the selected MME 208.

Numerous variants on the foregoing examples of decision logic 614 can be implemented according to exemplary embodiments. For example, as seen in FIG. 6(a), if the HeNB GW 502 forwards the S1AP INITIAL UE MESSAGE 612 to the MME 208 indicated by the MMEC in the S-TMSI included in that S1AP INITIAL UE MESSAGE 612, then the HeNB GW 502 may optionally also include an indication of the reason for the establishment in the message 616 towards the selected MME 208. This could be beneficial since the reason for the signaling connection would then be visible at an early stage to the core network, e.g., could be seen by lower layers and immediately at the S1AP layer without a need for decryption of the NAS message to determine if priority should be applied to the core network processing of the signaling connection request.

Moreover, as mentioned above, according to some embodiments it may be the case that the HeNB GW 502 rejects a request for a signaling connection. In such cases, the HeNB GW 502 can inform the HeNB 504 which sent the request about the rejected session by, for example, transmitting an S1AP RESET message to that HeNB 504. The cause IE in the S1AP RESET message could, for example, be set to ‘Control Processing Overload’. Another alternative would be to set that IE to ‘Load Balancing TAU Required’ to trigger a TAU Request from the UE 108. Yet another alternative is to use a new value for the cause IE in the reset message. An alternative to sending an S1AP RESET message when a session is rejected is to permit the HeNB GW 502 to silently (i.e. without indication to the sender) discard the received request and let the UE 108 and/or the HeNB 504 recovery actions be based on time supervision in those entities. This latter alternative could be beneficial to save bandwidth associated with signaling and processing power in the HeNB GW, e.g., for each RESET message which is sent by the HeNB GW 502, a corresponding acknowledge signal will subsequently be received and processed.

Additionally, as mentioned above, according to some embodiments it may be the case that the HeNB GW 502 selects a different MME 208 than the one which was addressed in the request for a signaling connection, e.g., if the addressed MME 208 is in a high load state and the reason for the requested signaling connection does not warrant connecting via the MME 208 in high load state based upon the particular decision logic used in an implementation. In such a case, after the HeNB GW 502 selects another MME 208 in the pool for this UE 108, the HeNB GW 502 forwards the S1AP Initial UE message to that selected MME 208. However, the newly selected MME 208 does not have the UE context for this UE 108. If the S1AP INITIAL UE MESSAGE contains the S-TMSI, the MME 208 could fetch the UE context from the previous MME 208 indicated by the MMEC in the S-TMSI. If no S-TMSI is included in the S1AP INITIAL UE MESSAGE, then the piggybacked NAS message is a TAU Request (which assumedly is unencrypted) that allows the new MME 208 to use the GUTI in the TAU Request to identify the previous MME 208 and fetch the relevant information from that MME 208 (just as during a regular TAU procedure).

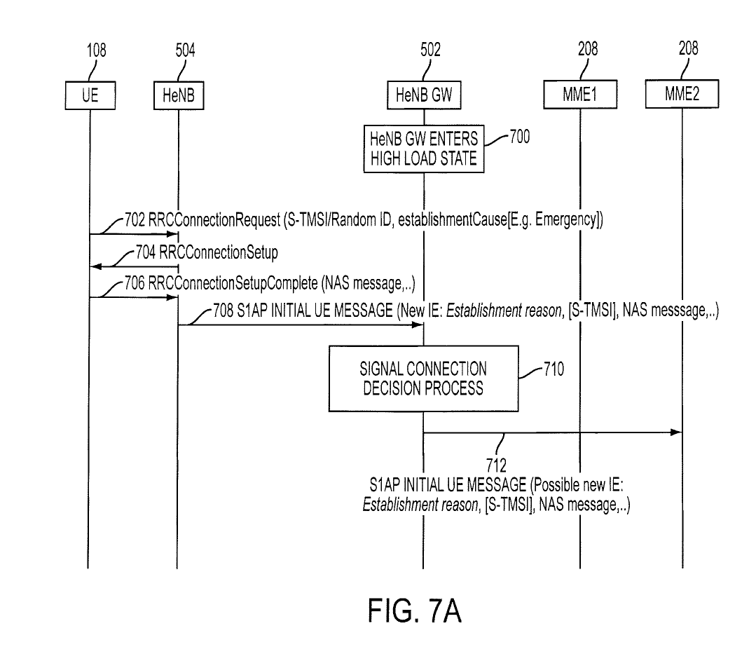

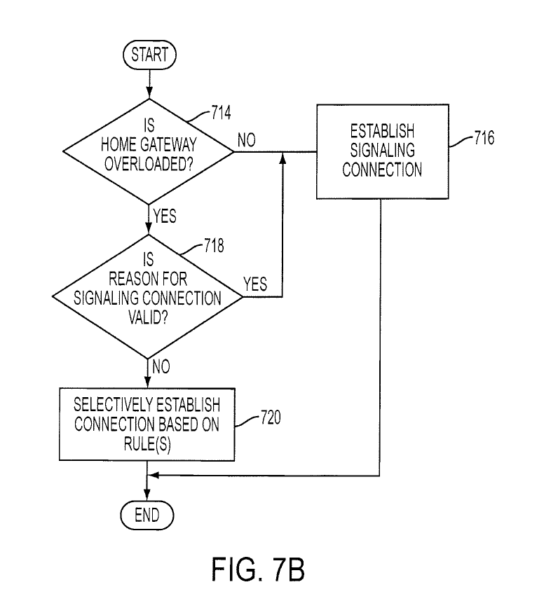

The present invention is not limited to the handling of high load situations associated with core network nodes, e.g., MMEs 208. According to another exemplary embodiment, illustrated in FIG. 7(a), a high load condition associated with the HeNB GW 502 (instead of, or in addition to the handling of high load condition(s) associated with MME(s) 208) can be considered in session or signaling connection establishment. As indicated by block 700, the HeNB GW 502 reaches a high load state and activates high load handling processes according to an exemplary embodiment. It will be appreciated by those skilled in the art that the actual metric or metrics which are used to determine when a home gateway 502 or core network node 310 should initiate high load handling processes will vary from implementation to implementation, and that the present invention is intended to encompass all such decision metrics. However, purely as an illustrative example and without limitation, a home gateway 502 or core network node could decide to initiate high load handling techniques in step 700 when they reach a predetermined processing or bandwidth limit, e.g., 80 or 90 percent of their processing or bandwidth capacity.

When a UE 108, which is being provided service coverage by an HeNB 504 connected to the now highly loaded HeNB GW 502, wants to establish a session, the UE 108 indicates the reason for the establishment in the establishmentCause IE in the RRCConnectionRequest message (signal 702) which is transmitted to the HeNB 504. This reason can, for example, include information associated with whether the requested connection is, e.g., an emergency connection (i.e. intended for an emergency call/session), a connection to transfer Mobile Originated Signaling, a connection to transfer Mobile Originated Data, etc. The HeNB 504 acknowledges receipt of the RRCConnectionRequest message 702 via acknowledgment signal 704. The UE 108 completes the RRC establishment procedure, and includes the upper layer message, i.e. the NAS message in the RRC message, via signal 706.

The HeNB 504 is not aware of the high load situation in the HeNB GW 502, so the HeNB 504 sends an S1AP INITIAL UE MESSAGE (signal 708) towards the HeNB GW 502 to establish an S1AP signaling connection for this UE session. The HeNB 504 includes the NAS message received from the UE 108 and can add other information, e.g., the S-TMSI. According to this exemplary embodiment, the HeNB 504 in this message also adds an indication of the reason for the requested signaling connection establishment. This indication could, for example, be the establishmentCause received in the RRCConnectionRequest 702, an ‘emergency indicator’ that is optionally included at emergency setups or other information associated with the reason(s) that the UE 108 requested this signaling connection. This new information element can optionally be included in message 708, and could for example only be inserted by the home base station 504 when an HeNB (or eNB) only has S1 interfaces/connections to one destination or when the HeNB (or eNB) serves CSG cells (or when the cell accessed by the UE is a CSG cell). These modes of operation would implicitly indicate that a HeNB GW 504 might be in the signaling path such that it becomes useful to include the reason information for high load handling according to these exemplary embodiments. Alternatively, inclusion of the reason for establishment information in message 708 could be mandatory regardless of whether a home gateway is in the signaling path or not.

The home gateway 502 then performs a signaling connection decision process as generally indicated by block 710. An example of such a decision process is illustrated in the flow diagram of FIG. 7(b). Therein, if the home gateway 502 can handle the session at step 714, i.e., if it is in a high load state, then normal handling applies for this request and home gateway 502 forwards the message to the addressed core network node 310 to establish the signaling connection at block 716 (or, if no core network node 310 in the connected pool is addressed, the home gateway 502 selects a new one using its default selection algorithm). If the home gateway 502 is in high load handling mode, the process follows the “Yes” path from block 714 to block 718, wherein the home gateway 502 checks to see if the if the received reason for establishment is valid/allowed, e.g., if it is an emergency call setup. If so, then the home gateway 502 forwards the S1AP INITIAL UE MESSAGE to the addressed or selected core network node 310 and continues to establish the signaling connection at block 716. Otherwise, if the received reason for establishment is not allowed thus following the “No” path from block 718, the home gateway 502 can have different policies for handling the requested signaling connection at step 720. For example, the home gateway 502 can reject the session establishment by sending an S1AP RESET message and receiving a corresponding acknowledgement message (neither of which are shown in FIG. 7(a)) or, alternatively, it can silently drop the received message and let UE/HeNB timeout actions occur. More generally, the home gateway 502 can selectively establish such a signaling connection at step 720 based upon at least one rule associated with a high load condition.

According to other exemplary embodiments, the home gateway 502 can have other policies for load regulation than those illustrated in FIG. 7(b). For example, a highly loaded home gateway 502 can allow all emergency signaling connection establishments and gradually reduce the number of allowed sessions for non-emergency signaling connections in order to obtain a smoother load regulation than current S1AP procedures allow. For example, the home gateway 502 could initially reject 10 percent of new non-emergency establishments by rejecting every 10^{th} request for a signaling connection establishment having a non-emergency reason. Then, if the high load situation persists or becomes more severe for that particular home gateway 502, it could gradually increase the number of rejected non-emergency establishments until the load drops below a high loading threshold.

Thus, returning to FIG. 7(a), for those exemplary embodiments wherein a home gateway 502 is either not highly loaded or is highly loaded but decides to permit a particular signaling connection request based upon its decision process 710, the home gateway 502 can transmit a signal 712 to a core network node 310. Alternatively, when a highly loaded home gateway 502 rejects a signaling connection establishment request, the home gateway 502 informs the home base station 504 about the rejected session by transmitting, for example, an S1AP RESET message (not shown in FIG. 7(a)) thereto. The cause IE in the S1AP RESET message could, for example, be set to ‘Control Processing Overload’ or, alternatively, to a new value for the cause IE. An alternative to sending an S1AP RESET message could be that the home gateway 502 discards the message received from the home base station 504 and lets UE/HeNB recovery actions be based on time supervision in those entities, which alternative could be beneficial to save bandwidth due to signaling and processing power in the home gateway 502 since, if a message, such as an S1AP RESET message, is sent to the home base station 504, the home base station 504 will reply with an acknowledgement message.

According to another exemplary embodiment, the HeNB GW 502 utilizes the S1AP OVERLOAD START/STOP procedure to process signaling connection requests when in a highly loaded state. That is, when the HeNB GW 502 reaches high load state, it sends an S1AP OVERLOAD START message to all, or a subset, of its connected HeNBs 504. When the HeNB GW 502's load decreases the HeNB GW 502 sends an S1AP OVERLOAD STOP message to each HeNB 504 to which it previously sent an S1AP OVERLOAD START message. For smooth load regulation the HeNB GW 502 can gradually, as the load increases, increase the number of HeNBs 504 to which it sends the S1AP OVERLOAD START message. Similarly, as the load decreases, the HeNB GW 502 can send the S1AP OVERLOAD STOP message to more HeNBs.

It will be appreciated by those skilled in the art that the above-described exemplary embodiments associated with home gateway, e.g., HeNB GW 502, behavior are applicable to communication systems other than LTE systems. For example, such embodiments could also be implemented in WCDMA (3G) femto solutions as well, wherein the HNB GW would be the high load handling point. Some differences may exist between LTE implementations of these exemplary embodiments and WCDMA implementations. For example, in WCDMA systems, the CN nodes (e.g., MSC/MSC server/SGSN) can send an ‘OVERLOAD’ message on the Iu interface. In such systems, the request message 612 by which a home base station requests a signaling connection can, for example, be a RANAP User Adaptation (RUA) message. The NAS messages on the Iu interface are not encrypted in WCDMA systems, so the HNB GW can determine priority by examining the NAS message. This allows an HNB GW to take similar actions as have been described herein for an HeNB GW.

According to some exemplary embodiments, a dedicated parameter is used in the S1AP messages to indicate priority (e.g., emergency), however another option is that an IP packet transmitted between an HeNB and an HeNB GW (e.g. an IP packet carrying an SCTP message which includes an S1AP message, such as the S1AP INITIAL UE MESSAGE) will carry this indication or information. The IP packet could, for example, carry such information using the QoS mechanisms available in an IP network, such as DIFFSERV (DIFFerentiated SERVices) and indicate priority with a special setting of the DSCP (DiffServ Code Point) field in the IP header. That is, the node, e.g., HeNB 504, which recognizes that the signaling refers to a priority session (e.g., emergency) sets the corresponding DSCP value. The receiving node can then, by examining the DSCP value, apply the correct priority to handling a connection request or otherwise use the priority information in its decision making process as described above.

According to exemplary embodiments, high load situations can be properly handled in conjunction with HeNB GWs 502 without increased signaling, need for processing power and increased complexity. Exemplary embodiments further support the handling of simultaneous high load in MME(s) 208 and HeNB GW(s) 502 without adding complexity and make it possible to introduce a smoother load regulation than what is currently possible with S1AP. At the same time exemplary embodiments conserve signaling, transmission bandwidth and processing, since the behavior described in these embodiments (e.g., for the highly loaded HeNB GW) also could be applied in an MME. For instance, a highly loaded HeNB GW (or MME) can flexibly and selectively reject sessions in order to optimally regulate the load, while evenly distributing the session rejections among its served (H)eNBs. Furthermore, to include an indication of the reason for the signaling connection or session establishment in the message towards an MME 208 can provide another benefit, since that information would then be visible at an early stage in connection establishment processing by the core network, e.g., such information could be seen by lower layers and immediately at the S1AP layer without a need for decryption. This, in turn, enables intermediate (software or hardware based) signaling processing in the core network to use that priority information without unnecessary decryption.

The exemplary embodiments described above provide methods and systems for session or signaling connection handling. As shown in FIG. 8, communications node 800 (which can generically represent, e.g., an HeNB 504 or an HeNB GW 502) can contain a processor 802 (or multiple processor cores), memory 804, one or more secondary storage devices 806 and a communications interface 808. As an HeNB 504, first communications interface 808 can include, for example, a transceiver configured to transmit signals to, and receive signals from, user equipments 108 over a radio interface and also a second communications interface 810, e.g., an IP interface such as Ethernet, for transmitting signals to, and receiving signals from, an HeNB GW 502. As an HeNB GW 502, the first communications interface 808 can be configured to transmit signals to, and receive signals from, a plurality of home base stations 504. Such signals can include the above-described request to establish a new signaling connection, wherein the request includes information associated with a reason for requesting establishment of the signaling connection. As an HeNB GW 502, the second communications interface 810 can be configured to transmit signals to, and receive signals from, a plurality of nodes (e.g., MMEs 208) associated with a radiocommunication network.

Communications node 800 can, therefore, be capable of processing instructions in support of performing the functions associated with an HeNB 504 or HeNB GW 502. For example, instructions can be stored in either memory 804 or secondary storage devices 806 which enable the processor 802 to determine whether to establish a new signaling connection based upon information associated with the reason for a connection establishment request and a load status of at least one of one of: (a) the home gateway and (b) at least one of the core network nodes associated with the radiocommunication network.

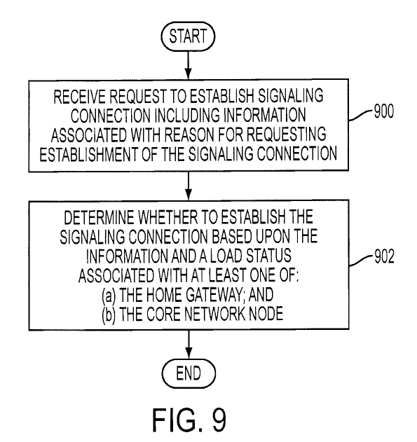

Thus, a method for signaling connection establishment in a home gateway according to an exemplary embodiment is illustrated in the flowchart of FIG. 9. Therein, at step 900, a request is received, at the home gateway, from a home base station to establish a signaling connection towards a core network node in a radiocommunication network, the request including information associated with a reason for requesting establishment of the signaling connection. Then, at step 902, the home gateway determines whether to (and towards which core network node to) establish the signaling connection based upon the information and a high load status associated with at least one of: (a) the home gateway and (b) the core network node in the radiocommunication network.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for signaling connection establishment in a home gateway, said home gateway being comprised in a radiocommunication network, the method comprising:
receiving, at said home gateway, a request from a home base station to establish a signaling connection towards a core network node, said request including information associated with a reason for requesting establishment of said signaling connection; and
determining, at said home gateway, whether to establish said signaling connection based upon said information and a load status associated with at least one of: (a) said home gateway and (b) said core network node in said radiocommunication network.

2. The method of claim 1, further comprising:
receiving, at said home gateway, a high load indication from said core network node; and
storing said high load indication.

3. The method of claim 2, further comprising:
receiving, at said home gateway, related information regarding allowable reasons for requesting establishment of signaling; and
storing said related information.

4. The method of claim 1, wherein said radiocommunication network is a Long Term Evolution (LTE) network, said home base station is a Home eNode B (HeNB) and provides radiocommunication service within a femtocell to a closed subscriber group, said home gateway is an HeNB gateway (HeNB GW) node which is connected to a plurality of home base stations and to a plurality of said core network nodes, and wherein said core network nodes include mobility management entities (MMES).

5. The method of claim 1, wherein said radiocommunication network is a Wideband Code Division Multiple Access (WCDMA) network, said home base station is a Home Node B (HNB) and provides radiocommunication service within a femtocell to a closed subscriber group, said home gateway is an HNB gateway (HNB GW) node which is connected to a plurality of home base stations and to a plurality of said core network nodes, and wherein said core network nodes include at least one of a Mobile Switching Center (MSC), a Mobile Switching Center Server and a Serving GPRS Support Node (SGSN).

6. The method of claim 1, wherein the request is an S1AP message.

7. The method of claim 1, wherein the request is a RANAP User Adaptation (RUA) message.

8. The method of claim 1, wherein said determining step is performed based on said load status of said home gateway as being in a high load condition and further comprising:
establishing said signaling connection if said information indicates that said request is associated with a category for allowable signaling connection establishment; and
otherwise, selectively establishing said signaling connection based upon at least one rule associated with said highly loaded condition of said home gateway.

9. The method of claim 1, wherein said determining step is performed based on said load status of said core network node and further comprising:
determining whether said request includes an identifier associated with a device which initiated said request;
if so, determining that said request is addressed to said core network node;
determining whether said core network node is currently highly loaded;
if so, determining whether said information matches a category for allowable signaling connection establishment; and
if so, establishing said signaling connection towards said core network node.

10. The method of claim 1, wherein said determining step is performed based on said load status of said core network node and further comprising:
determining whether said request includes an identifier associated with a device which initiated said request; and
if not, determining whether said information matches a category for allowable signaling connection establishment;
if so, then selecting said core network node with which to establish said signaling connection from among all of the core network nodes to which said home gateway is connected; and
otherwise, if said information does not match said category for allowable signaling connection establishment, then selecting said core network node with which to establish said signaling connection from among those core network nodes which are not highly loaded.

11. The method of claim 1, wherein said determining step is performed based on said load status of said core network node and further comprising:
determining whether said request includes an identifier associated with a device which initiated said request; and
if not, selecting said core network node with which to establish said signaling connection from among those core network nodes which are not highly loaded.

12. A home gateway comprising:
a first interface configured to transmit signals to, and receive signals from, a plurality of home base stations, said signals including a request to establish a signaling connection, said request including information associated with a reason for requesting establishment of said signaling connection;
a second interface configured to transmit signals to, and receive signals from, at least one core network node associated with a radiocommunication network; and
at least one processor configured to determine whether to establish said signaling connection based upon said information and a load status associated with at least one of: (a) said home gateway and (b) said at least one core network node.

13. The home gateway of claim 12, wherein said second interface is further configured to receive a high load indication from said core network node, and further comprising:
a memory device configured to store information associated with said high load indication.

14. The home gateway of claim 13, wherein said second interface is further configured to receive related information regarding allowable reasons for requesting establishment of signaling and wherein said memory device is configured to store said related information.

15. The home gateway of claim 12, wherein said radiocommunication network is a Long Term Evolution (LTE) network, said home base station is a home eNode B (HeNB) and provides radiocommunication service within a femtocell to a closed subscriber group, said home gateway is an HeNB gateway (HeNB GW) node which is connected to a plurality of home base stations and to a plurality of said core network nodes, and said core network nodes include mobility management entities (MMES).

16. The home gateway of claim 12, wherein said radiocommunication network is a Wideband Code Division Multiple Access (WCDMA) network, said home base station is a home Node B (HNB) and provides radiocommunication service within a femtocell to a closed subscriber group, said home gateway is an HNB gateway (HNB GW) node which is connected to a plurality of home base stations and to a plurality of said core network nodes, and said core network nodes include at least one of a Mobile Switching Center (MSC), Mobile Switching Center server and a Serving GPRS Support Node (SGSN).

17. The home gateway of claim 12, wherein the request is an S1AP message.

18. The home gateway of claim 12, wherein the request is a RANAP User Adaptation (RUA) message.

19. The home gateway of claim 12, wherein said at least one processor is configured to determine whether to establish said signaling connection based on said load status of said home gateway as being in a high load condition and further wherein said home gateway establishes said signaling connection if said information indicates that said request is associated with a category for allowable signaling connection establishment and, otherwise, selectively establishes said signaling connection based upon at least one rule associated with said high load condition of said home gateway.

20. The home gateway of claim 12, wherein said at least one processor is configured to determine whether to establish said signaling connection based on said load status of said core network node and further wherein said at least one processor is configured to:
determine whether said request includes an identifier associated with a device which initiated said request;
if so, determine that said request is addressed to said core network node;
determine whether said core network node is currently highly loaded;
if so, determine whether said information matches a category for allowable signaling connection establishment; and
if so, establish said signaling connection towards said core network node.

21. The home gateway of claim 12, wherein said at least one processor is configured to determine whether to establish said signaling connection based on said load status of said core network node and further wherein said at least one processor is configured to:
determine whether said request includes an identifier associated with a device which initiated said request; and
if not, determine whether said information matches a category for allowable signaling connection establishment;
if so, then select said core network node with which to establish said signaling connection from among all of the core network nodes to which said home gateway is connected; and
otherwise, if said information does not match said category for allowable signaling connection establishment, then select said core network node with which to establish said signaling connection from among those core network nodes which are not highly loaded.

22. The home gateway of claim 12, wherein said at least one processor is configured to determine whether to establish said signaling connection based on said load status of said core network node and further wherein said at least one processor is configured to:
determine whether said request includes an identifier associated with a device which initiated said request; and
if not, select said core network node with which to establish said signaling connection from among those core network nodes which are not highly loaded.

23. A method for signaling connection establishment in a home base station, said home base station, being comprised in a radiocommunication network, the method comprising:
transmitting, by said home base station, a request to establish a signaling connection towards a core network node, said request including information associated with a reason for requesting establishment of said signaling connection.

24. The method of claim 23 wherein said home base station has only one connection toward said radiocommunication network.

25. The method of claim 23, wherein said home base station has a limited set of subscribers for which it will establish signaling connections.
